(19) United States
(12) Patent Application Publication
(10) Pub. No.: US 2016/0140887 A1
(43) Pub. Date: May 19, 2016

(54) WEARABLE ELECTRONIC DEVICE

(71) Applicant: Samsung Electronics Co., Ltd., Gyeonggi-do (KR)

(72) Inventor: Tae-Seon KIM, Seoul (KR)

(21) Appl. No.: 14/944,337

(22) Filed: Nov. 18, 2015

(30) Foreign Application Priority Data
Nov. 18, 2014 (KR) 10-2014-0160952

(51) Int. Cl. G09G 3/00; G06F 3/01; G02B 27/01; G09G 3/34; G09G 3/36; G06F 1/16; G09G 3/32

(52) U.S. Cl. CPC G09G 3/003; G06F 1/163; G06F 3/013; G09G 3/3208; G09G 3/3406; G09G 3/36; G02B 27/0176; G02B 27/0172; G09G 2360/144; G09G 2320/0626; G02B 2027/0159; G02B 2027/014

(57) ABSTRACT

A head-mounted device includes a see-through display having an inner surface and an outer surface; a Display Driver Integrated Circuit (DDIC) for driving the display; and at least one processor for controlling the DDIC. A microcontroller may control the DDIC to display content through a specific area corresponding to eye tracking information acquired from an eye tracking module in a display area of the display.

### CLAIM OF PRIORITY

This application claims priority under 35 U.S.C. §119(a) from Korean Application Serial No. 10-2014-0160952, which was filed in the Korean Intellectual Property Office on Nov. 18, 2014, the entire content of which is hereby incorporated by reference.

### BACKGROUND

1. Field of the Disclosure

The present disclosure relates to electronic devices, in general, and more particularly to a wearable electronic device.

2. Description of the Related Art

Various types of electronic devices directly wearable on a user's body have been recently being developed. These devices are generally called a wearable electronic device. Examples of the wearable electronic device include a head mount type display (e.g., a head-mounted display), smart glasses, a smart watch or wristband, a contact lens type device, a ring type device, a shoes type device, a clothes type device, a glove type device, or the like. The wearable device may have various shapes capable of being detachable from a part of the user's body or clothes. The wearable electronic device may be directly worn on the user's body to improve portability and user's accessibility.

One example of the wearable electronic device includes a device that can be mounted on a user's head. Such a device may be called, for example, a head-mounted display or a Head-mounted Device (HMD).

### SUMMARY

According to aspects of the disclosure, a head-mounted device is provided comprising: a see-through display having an inner surface and an outer surface; a Display Driver Integrated Circuit (DDIC) for driving the display; and at least one processor for controlling the DDIC.

According to aspects of the disclosure, a method for operating a head-mounted device is provided having a see-through display and a lens, the method comprising: detecting, by the head-mounted device, a first input; activating the see-through display, in response to the first input; and extending the lens to an extended position at which the lens overlaps with the see-through display, in response to the first input.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram of an example of a head-mounted device, according to an embodiment of the present disclosure;

FIG. 2 is a diagram of an example of a head-mounted device, according to an embodiment of the present disclosure;

FIG. 3 is a diagram of an example of a head-mounted device, according to an embodiment of the present disclosure;

FIG. 4 is a diagram of an example of a Liquid Crystal Display (LCD) panel, according to an embodiment of the present disclosure;

FIG. 5 is a diagram of an example of an Organic Light Emitting Diode (OLED) panel, according to an embodiment of the present disclosure;

FIG. 6 is a diagram illustrating an example of the operation of a head-mounted device, according to an embodiment of the present disclosure;

FIG. 7 is a diagram of an example of the operation of a head-mounted device, according to an embodiment of the present disclosure;

FIG. 8 is a flowchart illustrating an example of a process for operating a head-mounted device, according to an embodiment of the present disclosure;

FIG. 9 is a flowchart illustrating an example of a process for operating a head-mounted device, according to an embodiment of the present disclosure;

FIG. 10 is a flowchart illustrating an example of a process for operating a head-mounted device, according to an embodiment of the present disclosure;

FIG. 11 is a flowchart illustrating an example of a process for operating a head-mounted device, according to an embodiment of the present disclosure;

FIG. 12 is a flowchart illustrating an example of a process for operating a head-mounted device, according to an embodiment of the present disclosure;

FIG. 13 is a diagram of an example of a lens actuator, according to an embodiment of the present disclosure;

FIG. 14 is a diagram of an example of a lens actuator, according to an embodiment of the present disclosure

FIG. 15 is a diagram of an example of a circuit for controlling an actuator of a head-mounted device, according to an embodiment of the present disclosure; and

FIG. 16 is a block diagram of an example of an external electronic device capable of communicating with a head-mounted device, according to an embodiment of the present disclosure.

Throughout the drawings, it should be noted that like reference numbers are used to depict the same or similar elements, features, and structures.

### DETAILED DESCRIPTION

The various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of various embodiments of the present disclosure as defined by the claims and their equivalents. It includes various specific details to assist in that understanding, but these are to be regarded as merely examples. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural references unless the context clearly dictates otherwise. Thus, for example, any reference to “a component surface” includes reference to one or more of such surfaces.

The expressions “include”, “may include”, etc. as used in the present disclosure refer to the existence of a corresponding disclosed function, operation or component which may be used in various embodiments of the present disclosure and do not exclude one or more additional functions, operations, or components. In the present disclosure, the expressions such as “include”, “have”, etc. may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof. The expression “or”, etc. as used in various embodiments of the present disclosure includes any or all of combinations of listed words. For example, the expression “A or B” may include A, may include B, or may include both A and B.

The expression “1”, “2”, “first”, or “second” used in various embodiments of the present disclosure may modify various components of various embodiments, but does not limit the corresponding components. For example, the above expressions do not limit the sequence and/or importance of the elements. The above expressions are used merely for the purpose of distinguishing an element from other elements. For example, a first user device and a second user device indicate different user devices although both of them are user devices. For example, without departing from the scope of the present disclosure, a first component element may be named a second component element. Similarly, the second component element also may be named the first component element.

It should be noted that if one component element is described as being “coupled” or “connected’ to another component element, the first component element may be directly coupled or connected to the second component, and a third component element may be “coupled” or “connected” between the first and second component elements. Conversely, when one component element is “directly coupled” or “directly connected’ to another component element, no third component element exists between the first component element and the second component element.

The terms in various embodiments of the present disclosure are used to describe various embodiments, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as would be understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

An electronic device according to various embodiments of the present disclosure may be a device that has a communication function. For example, the electronic device may include at least one of a smartphone, a tablet personal computer (PC), a mobile phone, a video phone, an e-book reader, a desktop PC, a laptop PC, a netbook computer, a personal digital assistant (PDA), a portable multimedia player (PMP), an MP3 player, a mobile medical device, a camera, and a wearable device (such as a head-mounted-device (HMD), electronic glasses, electronic clothes, an electronic bracelet, an electronic necklace, an electronic appcessory (e.g., an electronic device and/or counterpart accessory for a mobile device), an electronic tattoo, a smart watch, or the like).

According to various embodiments, the electronic device may be a smart home appliance with a communication function. The smart home appliance as an example of the electronic device may include at least one of, for example, a television, a Digital Video Disk (DVD) player, an audio player, a refrigerator, an air conditioner, a vacuum cleaner, an oven, a microwave oven, a washing machine, an air cleaner, a set-top box, a TV box (such as SAMSUNG HOMESYNC™, APPLE TV™, or GOOGLE TV™), a game console, an electronic dictionary, an electronic key, a camcorder, and an electronic picture frame.

According to various embodiments, the electronic device may include at least one of various medical appliances (such as Magnetic Resonance Angiography (MRA), Magnetic Resonance Imaging (MRI), Computed Tomography (CT) machine, and an ultrasonic machine), navigation devices, Global Positioning System (GPS) receivers, Event Data Recorders (EDRs), Flight Data Recorders (FDRs), automotive infotainment devices, electronic equipment for ships (such as navigation equipment for ships, gyrocompasses, or the like), avionics, security devices, head units for vehicles, industrial or home robots, Automatic Teller Machines (ATMs) of banking facilities, and Point Of Sales (POSs) of shops.

According to various embodiments, the electronic device includes at least one of furniture or a part of a building/structure, an electronic board, an electronic signature receiving device, a projector, and various types of measuring devices (for example, a water meter, an electric meter, a gas meter, a radio wave meter and the like). An electronic device according to various embodiments of the present disclosure may be a combination of one or more of above-described various devices. Also, an electronic device according to various embodiments of the present disclosure may be a flexible device. Also, an electronic device according to various embodiments of the present disclosure is not limited to the above-described devices. Hereinafter, an electronic device according to various embodiments will be described with reference to the accompanying drawings. The term “user” used in various embodiments refers to a person who uses an electronic device or a device (for example, an artificial intelligence electronic device) that uses an electronic device.

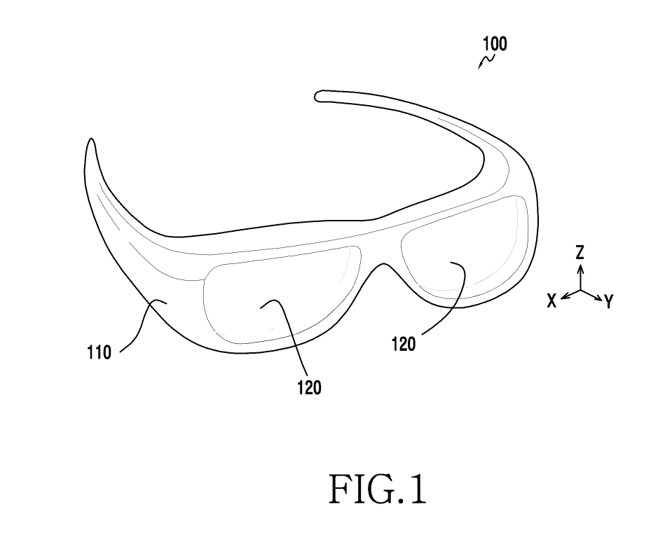

FIG. 1 is a diagram of an example of a head-mounted device, according to an embodiment of the present disclosure.

A head-mounted device 100 may be wearable on the head of a user. For example, the head-mounted device 100 (e.g., smart glasses) may be wearable on the head of the user by using eyeglass temples. Alternatively, the head-mounted device 100 may be wearable on the head of the user by using bands, helmets, straps, or the like including an elastic material.

Referring to FIG. 1, the head-mounted device 100 may include a frame 110 and a display 120.

The frame 110 may include any suitable type of framework and/or enclosure capable of containing a plurality of electronic components (e.g., the display 120) of the head-mounted device 100. In an embodiment, the frame 110 may include, for example, a touch panel (not shown) as a user interface in one outer portion thereof. The touch panel may include one or more lens adjusting units (not shown) disposed on an outer surface of the frame 110. In an embodiment, the frame 110 may include another type of an input device for controlling the head-mounted device 100. The control device may include, for example, at least one of a physical key, a physical button, a touch key, a joystick, a wheel key, and a touch pad. The touch pad may display a Graphic User Interface (GUI) (e.g., a GUI for controlling sound or image) capable of controlling a function of the head-mounted device 100. In an embodiment, the touch panel may receive a user's touch input (e.g., a direct touch input or a hovering input).

The frame 110 may be formed of a relatively light material (e.g., plastic) for a user's wearability. However, the frame may include any suitable type of material, such as glass, ceramic, metal (e.g., aluminum), or metal alloy (e.g., steel, stainless steel, titanium, or magnesium alloy for rigidity or good appearance.

The display 120 may be disposed in front of a user's eyes when the user wears the head-mounted device 100. According to an embodiment, the head-mounted device 100 may be configured such that a user can see content (e.g., games, movies, streaming, broadcasting, or the like) through the display 120.

According to an embodiment, the display 120 may have a light transmission property. For example, the user can see a real outer object(s) through the display 120.

According to various embodiments, the display 120 may have a planar shape or a curved shape.

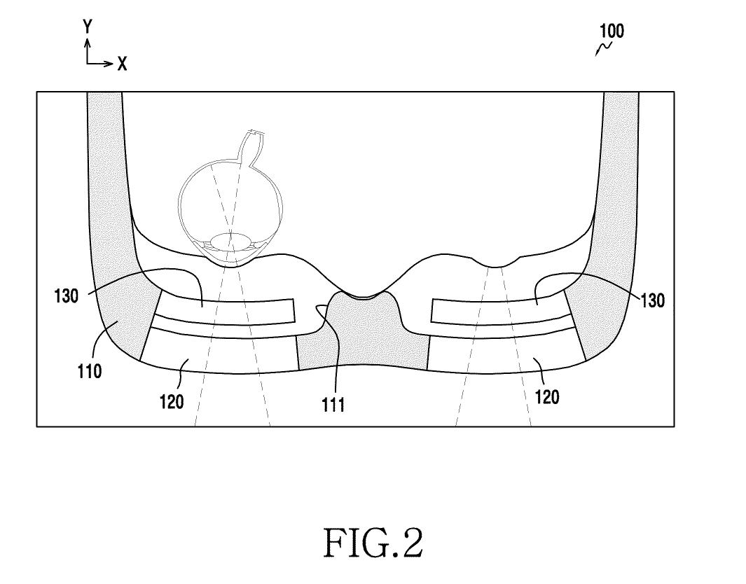

FIG. 2 is a diagram of an example of a head-mounted device, according to an embodiment of the present disclosure.

Referring to FIG. 2, a frame 110 may include a bridge 111. The bridge 111 may have a structure matched to the curve of a user's face, and may include, at least in part, an elastic member. For example, the bridge 111 may be adapted to rest on the user's nose.

According to an embodiment, the frame 110 may include a lens assembly 130. The lens assembly 130 may include a lens disposed at a position corresponding to the location of the user's eyes when the user is wearing the frame 110.

According to an embodiment, the lens assembly 130 may reposition the lens to overlap with the display 120. Alternatively, the lens assembly 130 may move the lens away from the display 120, and thereby the lens is not overlapped with the display 120.

According to various embodiments, the lens assembly 130 may move the lens in a folding manner. Alternatively, the lens assembly 130 may move the lens in a manner of inserting to an inner space of the frame 110. Alternatively, the lens assembly 130 may adjust a focal distance suitable for user's eyesight by adjusting a distance between the lens and the display 120.

According to an embodiment, the lens may include one of a hard lens and a liquid lens. For example, the liquid lens may include an electrolyte solution and an insulating solution, and a curvature of the lens can be transformed by a voltage applied to the electrolyte solution. Accordingly, the focal distance of the lens may be adjusted in such a manner that the curvature of the liquid lens is transformed by regulating the voltage.

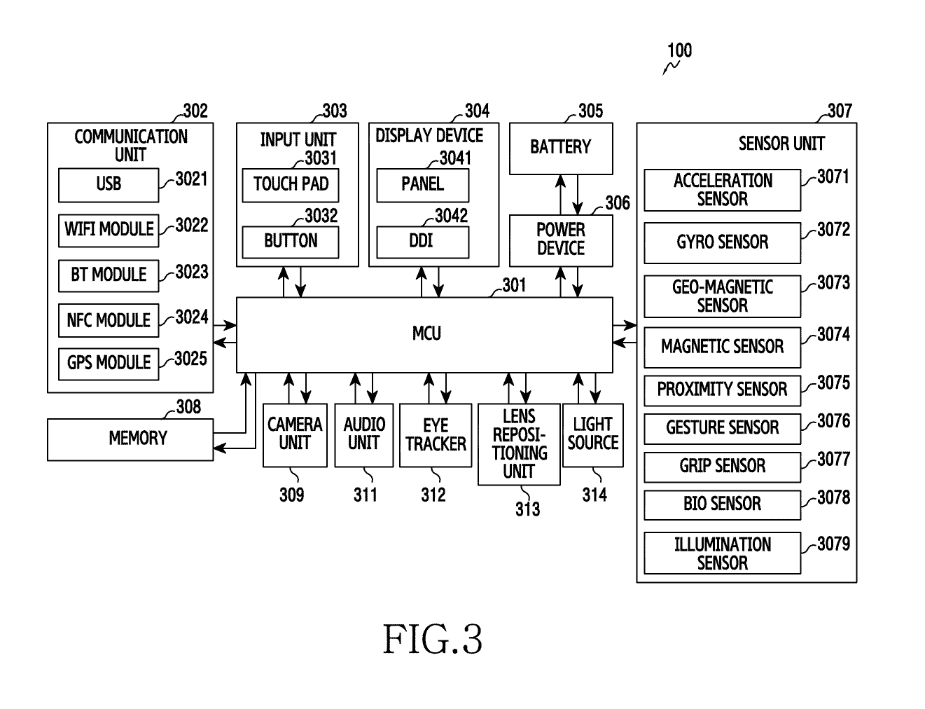

FIG. 3 is a block diagram of an example of a head-mounted device, according to an embodiment of the present disclosure.

According to an embodiments, a head-mounted device 100 may roughly include a Micro Controller Unit (MCU) 301, a communication unit (or a communication module) 302, an input unit (or an input device) 303, a display device (or a display module) 304, a battery 305, a power device (or a power management module) 306, a sensor unit (or a sensor module) 307, a memory 308, a camera unit (or a camera module) 309, an audio unit (or an audio module) 311, an eye tracker (or an eye tracking module) 312, a lens repositioning unit (or a lens repositioning module or lens assembly) 313, and a light source 314. Although not shown in the block diagram, the head-mounted device 100 may further include a vibrator for generating tactile signals.

The MCU 301 may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. The MCU 301 may include, for example, a processor, and may control a plurality of hardware components connected to the MCU by driving an Operating System (OS) or an embedded Software (S/W) program.

The communication unit 302 may electrically connect the head-mounted device 100 to one or more other electronic devices (e.g., a smartphone, a server, etc.) by using wired and/or wireless communication to perform data transmission/reception. According to an embodiment, the communication unit 302 may include one or more of a Universal Serial Bus (USB) 3021, a Wi-Fi module 3022, a Bluetooth (BT) module 3023, a Near Field Communication (NFC) module 3024, and a Global Positioning System (GPS) module 3025. According to an embodiment, at least some (e.g., two or more) of the Wi-Fi module 3022, the BT module 3023, the NFC module 3024, and the GPS module 3025 may be included in one Integrated Chip (IC) or IC package.

The input unit 303 may include any suitable type of input device. For example, the input unit 303 may include a touch pad 3031 and a button 3032. The touch pad 3031 may recognize a touch input, for example, by using at least one of an electrostatic type, a pressure-sensitive type, and an ultrasonic type. In addition, the touch pad 3031 may further include a control circuit. In case of the electrostatic type, a physical contact or a proximity recognition is possible. The touch pad 3031 may further include a tactile layer. In this case, the touch pad 3031 may provide the user with a tactile reaction. The button 3032 may include, for example, a physical button, an optical key, or a keypad.

The display device 304 may include a panel 3041 and a Display Driver IC (DDI) 3042. The panel (or display) 3041 may include a Liquid Crystal Display (LCD), an Organic Light Emitting diode (OLED), electronic ink, an Electronic Wetting Display (EWD), or the like.

According to an embodiment, the display 3041 may have a light transmission property (e.g., a display having a light transmittance). For example, the display 3041 having a light transmittance may be implemented in such a manner that a plurality of transparent or semitransparent areas capable of transmitting light are deployed together with pixels. Alternatively, the display 3041 having the light transmittance may be implemented in such a manner that a plurality of through-holes capable of transmitting light are deployed together with pixels. The DDI 3042 may present color by controlling a pixel of the display 3041. For example, the DDI 3042 may include a circuit which converts a digital signal into a Red, Green, and Blue (RGB) analog signal and delivers it to the display 3041.

The battery 305 may store or generate electricity, and may supply power to the head-mounted device 100 by using the stored or generated electricity. The battery 305 may include, for example, a rechargeable battery or a solar battery.

The power device 306 may control the supply of power to different components of the head-mounted device 100. Although not shown, the power device 306 may include, for example, a Power Management Integrated Circuit (PMIC), a charger Integrated Circuit (IC), a battery, or a fuel gauge.

The sensor unit 307 may measure a physical quantity or detect an operation state of the head-mounted device 100, and thus may convert the measured or detected physical quantity into an electric signal. The sensor unit 307 may include, for example, at least one of an acceleration sensor 3071, a gyro sensor 3072, a geo-magnetic sensor 3073, a magnetic sensor 3074, a proximity sensor 3075, a gesture sensor 3076, a grip sensor 3077, a biosensor 3078, an illumination sensor 3079, and/or any other suitable type of sensor.

According to an embodiment, at least one sensor (e.g., the acceleration sensor 3071, the gyro sensor 3072, and the geo-magnetic sensor 3073, and etc.) may be used to detect a motion of a user's head on which the head-mounted device 100 is worn.

According to an embodiment, at least one sensor (e.g., the proximity sensor 3075, the grip sensor 3077, and etc.) may be used to detect whether the head-mounted device 100 is being worn.

According to various embodiments, the head-mounted device 100 may detect whether the user wears the head-mounted device 100 by using at least one of an infrared (IR) sensor, a pressure sensor, and/or a capacitive sensor.

According to various embodiments, the gesture sensor may detect a motion of a user's hand or finger and may receive it as an input action of the head-mounted device 100.

According to various embodiments, the sensor unit 307 may detect user's biometric information by using a biosensor such as an E-nose sensor, an ElectroMyoGraphy (EMG) sensor, an Electroencephalogram (EEG) sensor, an Electrocardiogram (ECG) sensor, an iris sensor, a refraction sensor, or the like.

According to various embodiments, the sensor unit 307 may further include a control circuit for controlling any sensors that might be included therein.

The memory 308 may include any suitable type of volatile or non-volatile memory, such as Random Access Memory (RAM), Read-Only Memory (ROM), Network Accessible Storage (NAS), cloud storage, a Solid State Drive (SSD), etc. For example, the memory 308 may store an instruction or data received from the MCU 301 or other constitutional elements (e.g., the display device 304, the communication unit 302, the input device 303, the sensor module 307, etc.) or generated by the MCU 301 or other constitutional elements.

The camera unit 309 is a device for image and video capturing, and according to an embodiment, may include one or more image sensors, a lens (not shown), an Image Signal Processor (ISP, not shown), or a flash (not shown, e.g., LED or xenon lamp).

The audio unit 311 may bilaterally convert a sound and electronic signal. The audio unit 311 may process sound information which is input or output, for example, through a speaker, an earphone, a microphone, or the like.

According to various embodiments, the eye tracker 312 may track user's eyes. For example, the eye tracker 312 may track by using one of an Electrical OculoGraphy (EOG) sensor, coil systems, dual Purkinje systems, bright pupil systems, and dark pupil systems. Further, the eye tracker 312 may further include a micro camera for eye tracking.

According to various embodiments, the lens repositioning unit 313 may position the lens between the user's eye and the display 3041, thereby causing the user to see through the lens any images that are presented on the display 3041. Alternatively, when the display 3041 is in a deactivated state, the lens positioning unit 313 may move the lens to a position where the lens does not overlap with the display 3041. Alternatively, the lens positioning unit 313 may reposition the lens so that the user can enjoy an image suitable for user's eyesight. For example, the lens repositioning unit 313 may examine a refraction for the user's eyes, and may reposition the lens according to a result of the examination. Alternatively, the lens repositioning unit 313 may measure an Inter-Pupil Distance (IPD) of the user to reposition the lens.

According to various embodiments, at least one light source 314 (e.g., a Backlight Unit (BLU) or a Light Emitting Diode (LED)) may be activated to provide light when the user cannot see the image of the display 3041 due to a poor ambient illumination.

Each of the aforementioned constitutional elements of the head-mounted device 100 according to an embodiment of the present disclosure may include one or more components, and names thereof may vary depending on a type of the head-mounted device. The head-mounted device according to an embodiment of the present disclosure may include at least one of the aforementioned constitutional elements. Some of the constitutional elements may be omitted, or additional other constitutional elements may be further included. In addition, some of the constitutional elements of the head-mounted device according to embodiments of the present disclosure may be combined and constructed as one entity, so as to equally perform functions of corresponding constitutional elements before combination.

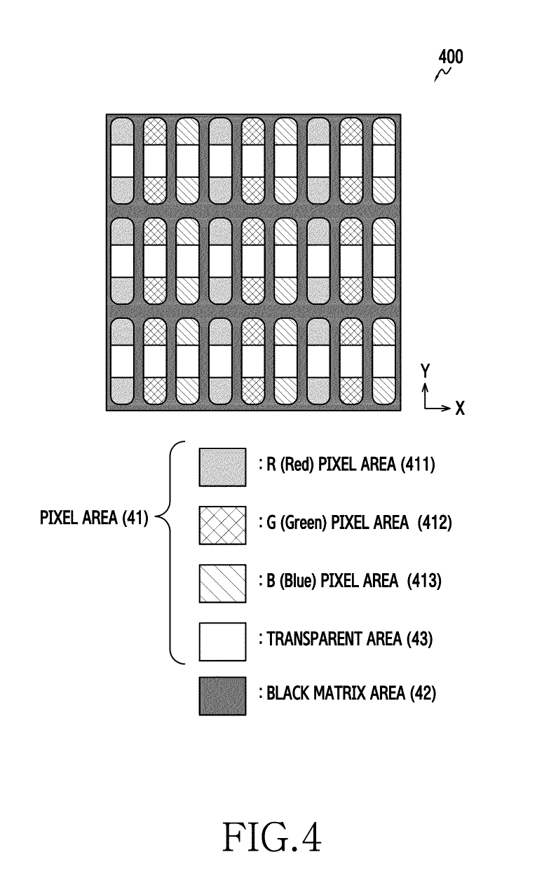

FIG. 4 is a diagram of an example of a Liquid Crystal Display (LCD), panel, according to various embodiments of the present disclosure. Although not shown, an LCD panel 400 may include a Thin Film Transistor (TFT) substrate, a color filter substrate, a liquid crystal, or the like.

The TFT substrate may include a gate line, a data line, a pixel electrode, and a TFT. The gate line (or a scanning signal line) may be disposed between pixel areas 41, and may deliver a scanning signal or a gate signal. The data line may be orthogonal to the gate line, may be disposed between the pixel areas 41, and may deliver the data signal. Each pixel area 41 may be disposed at a respective intersection of the gate line and the data line. A pixel electrode may be disposed in each pixel area. The TFT may include a gate electrode electrically connected to the gate line, a source electrode electrically connected to the data line, and a drain electrode electrically connected to the pixel electrode.

The color filter substrate may include a filter pattern (e.g., a color filter pattern, a block matrix pattern) for implementing color and a common electrode (e.g., ITO). The color filter pattern (e.g., a red filter pattern, a green filter pattern, a blue filter pattern) may be disposed on the pixel areas 41. The black matrix pattern (e.g., a black pattern) may be separated from the color filter pattern. The common electrode may be disposed between the filter pattern and the liquid crystal.

The liquid crystal may be disposed between the TFT substrate and the color filter substrate.

An electric field between the pixel electrode of the TFT substrate and the common electrode of the color filter substrate may change an array of molecules of the liquid crystal. Light from an external light source (e.g., a backlight unit or the Sun) may penetrate the liquid crystal and the color filter pattern, and thus the pixel area 41 may emit light. Referring to FIG. 4, the LCD panel may include a plurality of pixel areas 41, a black matrix area 42, and a transparent area 43.

Referring to FIG. 4, according to an embodiment, the LCD panel 400 may include the plurality of pixel areas 41, the black matrix area 42, and the transparent area 43.

Each of the plurality of pixel areas 41 may be the basic building block of any of the pixels in the LCD panel 400. The plurality of pixel areas 41 have the same shape in general as illustrated, and may be regularly arranged in parallel in a row direction (e.g., an X-axis direction) or a column direction (e.g., a Y-axis direction), but the present disclosure is not limited thereto. As one unit of presenting one color, one dot may constitute a pixel group including three pixel areas (e.g., a red pixel area 411, a green pixel area 412, and a blue pixel area 413). Herein, each of the three pixel areas (e.g., the red pixel area 411, the green pixel area 412, and the blue pixel area 413) may emit red light, green light, and blue light, respectively, according to the pixel area's respective filter, such as the red filter, the green filter and the blue filter. The pixel areas may be arranged in rows and/or columns, as illustrated. Alternatively, although not shown, the pixel group is not limited to the three pixel areas, and thus may include three or more pixel areas.

The black matrix area 42 is separated from the pixel areas 41. For example, the black matrix area 42 may surround the pixel areas 41. The black matrix area 42 may block light by using a black color filter substrate. The gate line, data line, and TFT of the aforementioned TFT substrate may be disposed to the black matrix area 42.

According to an embodiment, the transparent area 43 may be disposed on an inner portion (e.g., a center portion) of the pixel areas 41. Light directed to one surface of the LCD panel 400 may be transmitted to an opposite side of the LCD panel 400 through the transparent area 43. For example, even if the LCD panel 400 is present in front of a user's eyes, the user can see an outer object in front through the transparent area 43. Herein, in the pixel electrode of the aforementioned TFT substrate, a portion overlapping with the transparent area 43 may be omitted. In addition, in the filter pattern of the aforementioned color filter substrate, a portion overlapping with the transparent area 43 may be omitted or may be formed to be transparent.

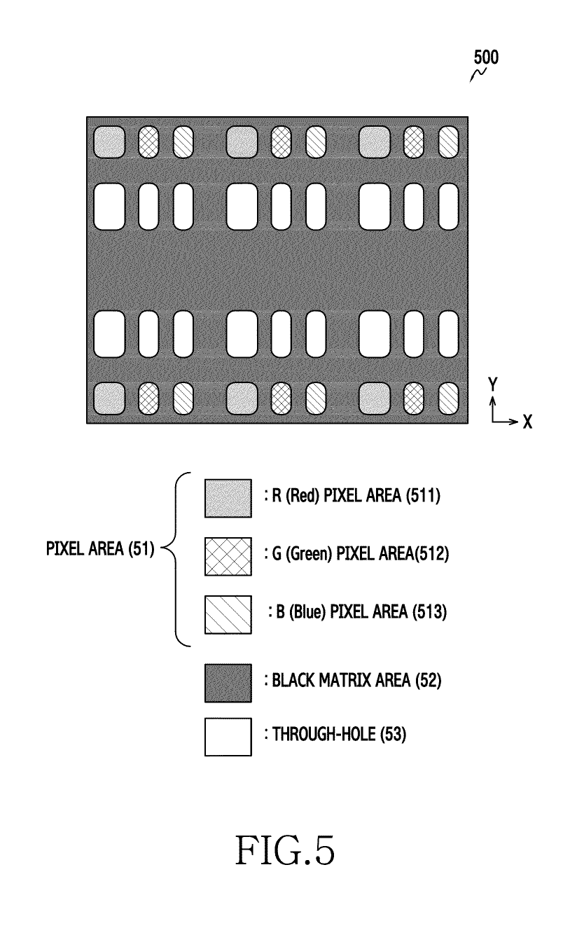

FIG. 5 is a diagram of an example of an Organic Light Emitting Diode (OLED) panel, according to various embodiments of the present disclosure. Although not shown, an OLED panel 500 may include an array of OLED elements disposed on a screen. Each of the OLED element may form a pixel. Each OLED element may be constructed in such a manner that an organic light emitting material is deposited between a cathode electrode and an anode electrode. Current may flow to the organic light emitting material between the two electrodes, and the organic light emitting material may emit light by using an electric field light emitting phenomenon.

The OLED panel 500 may display color by using a three-color (i.e., red, green, and blue) independent pixel, a Color Change Medium (CCM), a color filter, or the like. For example, the OLED panel 500 may present a particular color by combining OLED elements having three types of color (i.e., red, green, and blue).

The OLED panel 500 may be one of a Passive Matrix Organic Light Emitting Diode (PMOLED) panel and an Activate Matrix Organic Light Emitting Diode (AMOLED). For example, the AMOLED panel 500 may have a TFT embedded in each AMOLED element to individually control whether each AMOLED element emits light. When forward voltage is applied to the TFT, current may flow to an organic light emitting material at voltage greater than or equal to a specific threshold, and the organic light emitting material may emit light. For example, the greater the current flowing to the organic light emitting material, the brighter the light emitted from the organic light emitting material. By contrast, when reverse voltage is applied to the TFT, current does almost not flow to the organic light emitting material, and the organic light emitting material cannot emit light.

As illustrated in FIG. 5, the OLED panel 500 may include a plurality of pixel areas 51, a block matrix area 52, and a plurality of through-holes 53.

Each of the plurality of pixel areas 51 may be used to form a respective pixel. The plurality of pixel areas 51 have the same shape in general as illustrated, and may be regularly arranged in rows and columns, but the present disclosure is not limited thereto. Each pixel in the OLED panel 500 may be formed by three pixel areas (e.g., a red pixel area 511, a green pixel area 512, and a blue pixel area 513) which can emit three-color (i.e., red, green, and blue) light. In addition, the pixels are not limited to including any particular number of pixel areas, and thus may include more (or less) than three pixel areas. The aforementioned organic light emitting material may be disposed to the pixel areas 51.

The black matrix area 52 (e.g., a black color area) may surround the pixel areas 51 to distinguish the pixel area 51. For example, the black matrix area 52 may include a black matrix of a color filter, or may include a separator for separating AMOLED elements from each other. The aforementioned TFT and at least one part of a circuit related thereto may be disposed to the black matrix area 52.

According to an embodiment, the plurality of through-holes 53 may be formed in the black matrix area 42. For example, any of the plurality of through-holes 53 may be disposed in the space between two respective pixels. The pixel density of the OLED panel 500 may be measured in Pixels per Inch (PPI). The plurality of through-holes 53 may be formed in a portion not having a circuit (e.g., a TFT or the like).

Light entering one surface of the OLED panel 500 may be transmitted straight to an opposite side of the OLED panel 500 through the plurality of through-holes 53. Thus, even when the OLED panel 500 is present in front of user's eyes, the user would be able to see objects located in front of the user through the plurality of through-holes 53.

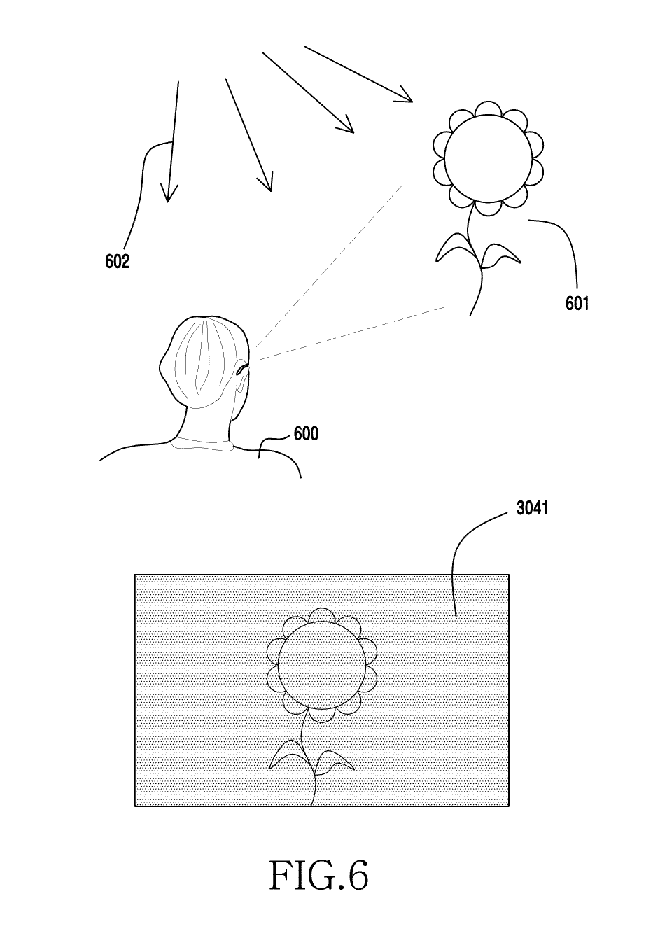

FIG. 6 is a diagram illustrating an example of the operation of a head-mounted device, according to an embodiment of the present disclosure.

For example, a user 600 wearing the head-mounted device 100 may see an object 601 through the head-mounted device 100. According to an embodiment, as described above, a display (e.g., the LCD panel 400 or the AMOLED panel 500) of the head-mounted device 100 may be see-through.). In some implementations, the display may have a light transmittance of 10-20%. In other words, external light 602 may be transmitted through the display 400 or 500 in a deactivated state. Therefore, the user may feel a light transmission effect as if the user sees the object 601 by wearing typical sunglasses.

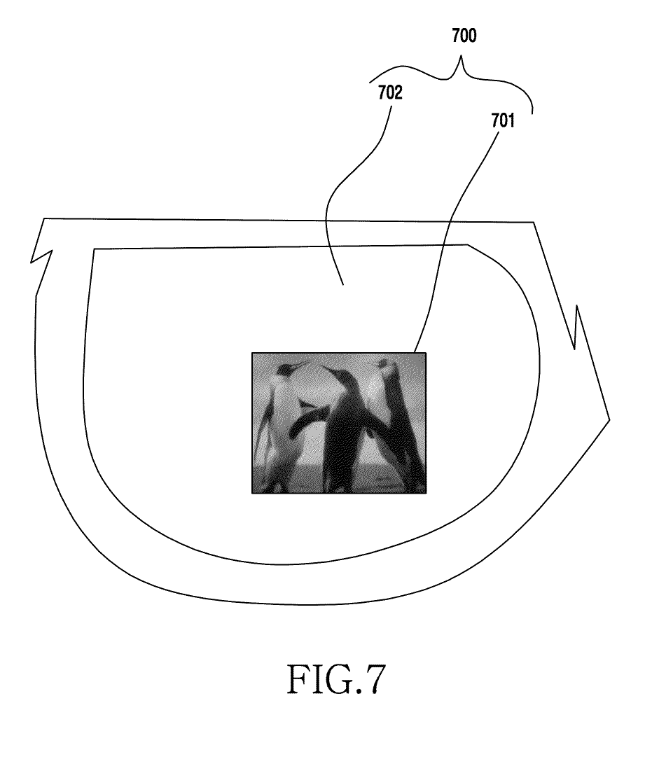

FIG. 7 is a diagram of an example of the operation of a head-mounted device, according to an embodiment of the present disclosure.

Referring to FIG. 7, a display 700 (e.g., the LCD panel 400 or the OLED panel 500) of the head-mounted device 100 may display an image. According to an embodiment, although the image may be displayed in one portion 701 in a display area of the display 700, the present disclosure is not limited thereto. The image of the display 700 may be displayed by using ambient lighting (e.g., sunlight, electric light, etc.) instead of a dedicated backlight.

According to various embodiments, alternatively, if it is determined that the image of the display 700 is difficult to be visible to the user's eyes due to insufficient external light, the head-mounted device 100 may activate the light source 314 of FIG. 3.

According to various embodiment, alternatively, in order to present the image more clearly, an area 702 in which the image is not displayed may be presented in grey, black, or the like, so that a blackout effect can be expected.

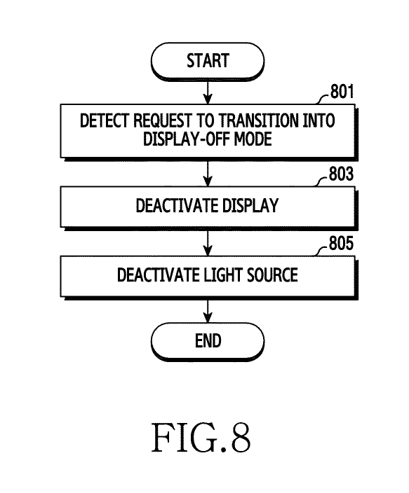

FIG. 8 is a flowchart illustrating an example of a process for operating a head-mounted device, according to an embodiment of the present disclosure.

According to the process, in operation 801, the controller (e.g., the MCU or the processor) 301 may detect a request for transitioning the head-mounted device into a display-off mode. For example, the request may include a user input (e.g., specific button pressing, a touch input, a gesture input, etc.) via the input device 303. Alternatively, the request for the display-off mode may include an interrupt for performing of a pre-set operation (e.g., an interrupt for entering sleep mode, an interrupt for entering a power-saving mode, etc.).

In operation 803, the MCU 301 may deactivate a display (e.g., the LCD panel 400 or the OLED panel 500). For example, the MCU 301 may deactivate the display 400 or 500 through a control of the DDI 3042.

In operation 805, the MCU 301 may deactivate the light source 314.

According to an embodiment, a user can see an object in front of the head-mounted device 100 via a see-through portion (e.g., the transparent area 43 of FIG. 4 or the through-hole 53 of FIG. 5) of the display 400 or 500.

According to various embodiments, although not shown, the MCU 301 may deactivate the illumination sensor 3077 when the head-mounted device is transitioned into the display-off mode.

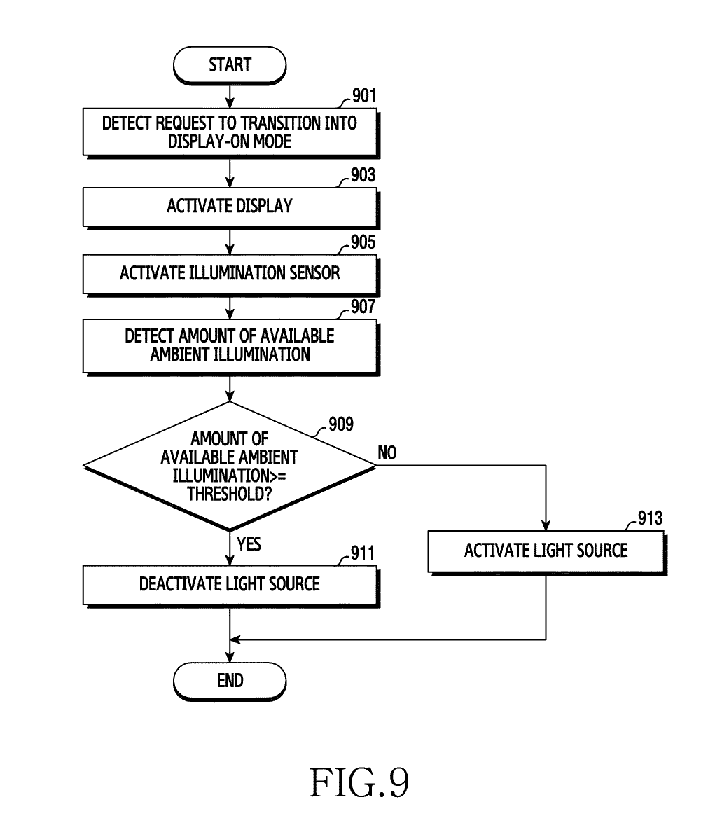

FIG. 9 is a flowchart illustrating an example of a process for operating a head-mounted device, according to an embodiment of the present disclosure.

According to the process, in operation 901, the MCU 301 may detect a request for transitioning the head-mounted device into a display-on mode. For example, the request may include a user input (e.g., specific button pressing, a touch input, a gesture input, etc.) via the input device 303. According to an embodiment, the request for the display-on mode may be detected when the user moves a hand in a predetermined manner in front of the head-mounted device 100. Alternatively, the request for the display-on mode may be detected when triggering eye movements in such a manner that the user blinks eyes by a determined number of times within a threshold time period. Additionally or alternatively, the request for the display-on mode may occur by means of an alarm, an alert message, or the like. Additionally or alternatively, the request for the display-on mode may be detected by means of message reception, call reception, or the like. In addition thereto, embodiments based on various situations may be possible.

In operation 903, the MCU 301 may activate a display (e.g., the LCD panel 400).

In operation 905, the MCU 301 may activate the illumination sensor 3077.

In operation 907, the MCU 301 may acquire a measurement of the available ambient illumination from the illumination sensor 3077. Alternatively, although not shown, the MCU 301 may acquire the measurement of the ambient illumination from an external head-mounted device (e.g., a smartphone, a server, or the like) capable of communicating with the head-mounted device 100. For example, the measure of the ambient illumination may indicate the amount of light that is incident on the inner surface (e.g., a surface facing the user) or the outer surface (e.g., a surface facing away from the user) of the display 400. Alternatively, various features having an effect on whether the image of the display 400 is visible to user's eyes may be used instead of the aforementioned illumination.

In operation 909, the MCU 301 may determine whether the illumination is greater than or equal to a threshold (e.g., 300 lux).

According to an embodiment, if the amount of available ambient illumination is greater than or equal to the threshold, in operation 911, the MCU 301 may deactivate the light source 314. In such situations, images may be presented on the display 400 by using only light from an external light source as backlight (e.g., sunlight, electric light, etc.).

According to an embodiment, if the illumination is less than the threshold, in operation 913, the MCU 301 may activate the light source 314, and may adjust the brightness of the light source 314 on the basis of the measurement that is taken at operation 907. For example, adjusting the brightness of the light source 314 may permit the user to see any images that are displayed on the display when there is little ambient light available. In addition, the adjustment of the brightness of the light source 314 may facilitate to decrease power consumption.

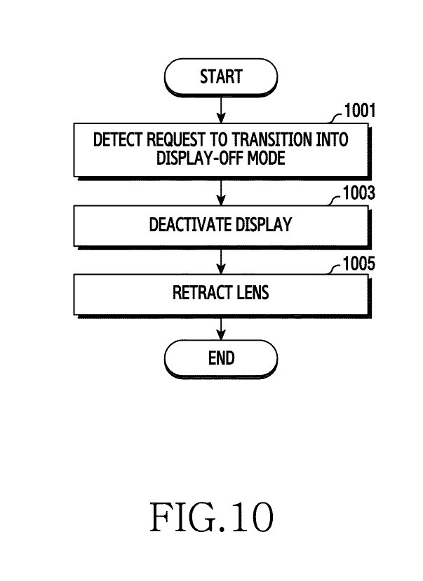

FIG. 10 is a flowchart illustrating an example of a process for operating a head-mounted device, according to an embodiment of the present disclosure.

According to the process, in operation 1001, the MCU 301 may detect a request for transitioning the head-mounted device into a display-off mode.

In operation 1003, the MCU 301 may deactivate a display (e.g., the LCD panel 400 or the OLED panel 500) in response to the request.

In operation 1005, the MCU 301 may retract the lens of the head-mounted device. More particularly, the MCU 301 may control the lens repositioning module 313 so that the lens is relocated to a position where it does not overlap with the display 400 or 500.

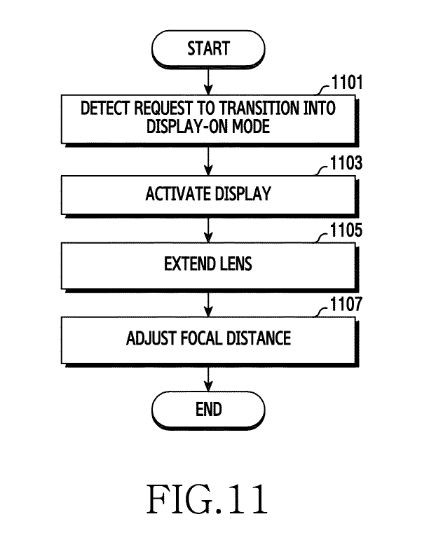

FIG. 11 is a flowchart illustrating an example of a process for operating a head-mounted device, according to another embodiment of the present disclosure.

According to the process, in operation 1101, the MCU 301 may detect a request for transitioning the head-mounted device into a display-on mode.

In operation 1103, the MCU 301 may activate a display (e.g., the LCD panel 400 or the OLED panel 500) in response to the request.

In operation 1105, the MCU 301 may extend the lens of the head-mounted device. More particularly, the MCU 301 may control the lens repositioning module 313 so that the lens is disposed to a position overlapping with the display 400 or 500.

In operation 1107, the MCU 301 may control the lens repositioning module 313 for repositioning (e.g., moving) the lens to have focal distance suitable for user's eyes. According to an embodiment, the lens repositioning module 313 may examine a refraction of the user's eyes, and may reposition the lens according to a result of the examination. For example, the lens repositioning module 313 may use the biosensor 3076 of the sensor module 307 to examine the refraction of the user's eyes.

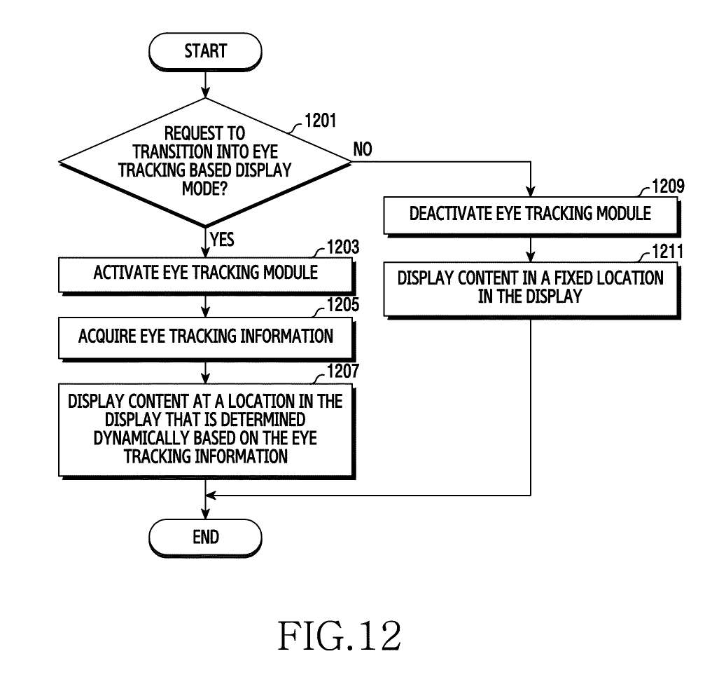

FIG. 12 is a flowchart illustrating an example of a process for operating a head-mounted device, according to various embodiments of the present disclosure.

Referring to FIG. 12, in operation 1201, the MCU 301 may detect whether a request is received for transitioning the head-mounted device into an eye-tracking display mode. For example, the request may include a user input (e.g., specific button pressing, a touch input, a gesture input, etc.) via the input device 303.

According to an embodiment, if the request for the eye-tracking display mode is received, in operation 1203, the MCU 301 may activate an eye-tracking module of the head-mounted device (e.g., the eye tracker 312 of FIG. 3).

In operation 1205, the MCU 301 may acquire eye-tracking information associated with the user's eyes from the eye-tracking module 312.

In operation 1207, the MCU 301 may display content in an area of the display (e.g., the LCD panel 400 or the OLED 500) that is selected dynamically based on the eye-tracking information. For example, an area for displaying the content may be repositioned according to eye movements of the user, and the content may be sensed by the user's eyes.

According to an embodiment, if no request for transitioning the head-mounted device into the eye-tracking display mode is received, the MCU 301 may deactivate the eye-tracking module in operation 1209 and display the content in a designated area in the display in operation 1211.

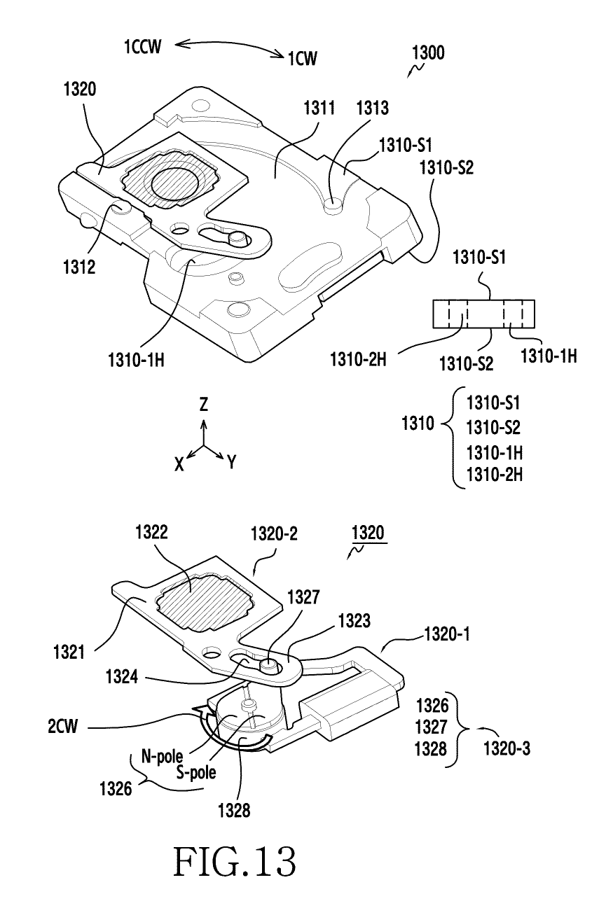

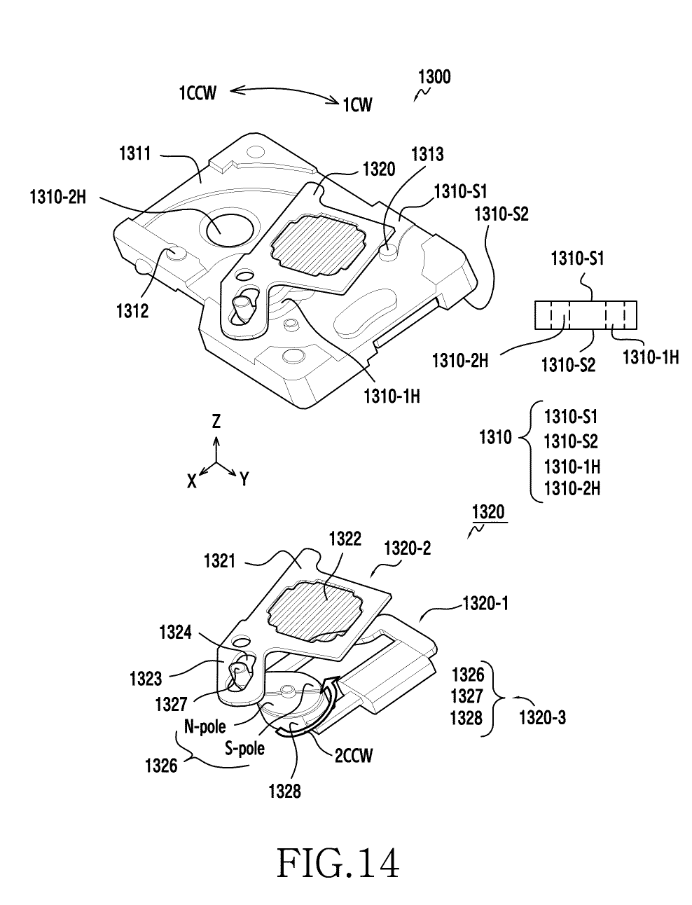

FIG. 13 and FIG. 14 illustrate an example of a lens actuator, according to an embodiment of the present disclosure. According to the example, an actuator 1300 may include the aforementioned lens repositioning module 313. In addition, the actuator 1300 may include a fixed body 1310 and a movable body 1320.

According to an embodiment, the fixed body 1310 has a generally flat shape, and may include a top surface 1310-S1, a bottom surface 1310-S2, a first through-hole 1310-1H, and a second through-hole 1310-H2.

According to an embodiment, the top surface 1310-S1 may include a recess 1311, a first projection 1312, and a second projection 1313. The recess 1311 may receive a blade 1320-2 of the movable body 1320, such that the blade 1302-2 of the movable body 1320 may move inside the recess 1311. The first projection 1312 may limit the rotation of the blade 1302-2 in a counter-clockwise direction 1CCW. For example, when the movable body 1320 is in an extended position, the blade 1320-2 of the movable body 1320 may be brought in contact with the first projection 1312 and thus may no longer be able to rotate. The second projection 1313 may limit the rotation of the blade 1320-2 in a clockwise direction 1CW. For example, when the movable body 1320 is in a retracted position, the blade 1320-2 of the movable body 1320 is brought in contact with the second projection 1313 and thus may no longer be able to rotate.

According to an embodiment, the bottom surface 1310-S2 may include a recess arranged to receive an install plate 1320-1 of the movable body 1320.

According to an embodiment, the first through-hole 1310-1H may pass through the fixed body 1310 and receive at least a part of a rotation unit 1320-3 of the movable body 1320. According to an embodiment, the second through-hole 1310-2H may also pass through the fixed body 1310. A display (not shown, e.g., the LCD panel 400 or the OLED panel 500) may be disposed in (or adjacent to) the second through-hole 1310-2H for viewing by the user.

According to an embodiment, the install plate 1320-1 may be coupled to the bottom surface 1310-S2 of the fixed body 1310. The install plate 1320-1 may have a ring shape.

According to an embodiment, the blade 1320-2 may be connected to the rotation unit 1320-3, and may rotate by means of the rotation unit 1320-3 in the recess 1311 of the fixed body 1310. The blade 1320-2 may include a lens install unit 1321 and a shaft connection unit 1323. The lens install unit 1321 may include a lens 1322 disposed therein. The shaft connection unit 1323 may extend from the lens install unit 1321, and may include a through-groove 1324 capable of receiving the shaft 1327 of the rotation unit 1320-3.

According to an embodiment, the rotation unit 1320-3 may be installed in the install plate 1320-1. The rotation unit 1320-3 may include a magnet 1326 (e.g., a permanent magnet, electromagnet, etc.), the shaft 1327, and an electromagnet 1328. The magnet 1326 may have an N-pole and an S-pole, and may be coupled to the electromagnet 1328 in a rotatable manner. The shaft 1327 may extend vertically (i.e., in the Z-axis direction) from one side of the magnet 1326. The shaft 1327 may be inserted through the through-groove 1324 of the blade 1320-2. The electromagnet 1328 may include an electromagnetic coil, and the electromagnetic coil may generate electromagnetic force for rotating the movable body 1320.

Referring to FIG. 13, according to an embodiment, when the blade 1320-2 of the movable body 1320 is fully extended, the lens 1322 of the blade 1320-2 may overlap with the second through-hole 1310-2H of the fixed body 1310. For example, if forward current is applied to the electromagnet 1328 of the rotation unit 1320-3 of the movable body 1320, an electromagnetic force is generated, and the magnet 1326 may rotate the shaft 1327 in a clockwise direction 2CW, thereby causing the blade 1320-2 of the movable body 1320 to rotate with the shaft 1327 to a position in which the movable body is fully retracted (see FIG. 14).

Referring to FIG. 14, according to an embodiment, if the blade 1320-2 of the movable body 1320 is fully retracted, the lens 1322 of the blade 1320-2 does not overlap with the second through-hole 1310-2H of the fixed body 1310. When the movable body 1320 is retracted, if reverse current is applied to the electromagnet 1328, the shaft 1327 of the rotation unit 1320-3 of the movable body 1320 will rotate in the counterclockwise direction 2CCW, thereby causing the blade 1320-2 to become extended (see FIG. 13).

Stated succinctly, FIG. 13 depicts the lens actuator 1300 when the lens 1320 is extended, and FIG. 14 depicts the lens actuator 1300 when the lens 1322 is retracted. When the lens 1322 is extended, the lens 1322 is aligned with a through hole 1310-2H, such that the user can view a display (e.g., a see-through display) through the lens 1322 and the through-hole 1310-2H. When the lens 1322 is retracted, the lens 1322 is not aligned with the through-hole 1310-2H.

As noted above, the lens actuator 1330 may be part of a head-mounted device. In some embodiments, the lens 1322 may be automatically rotated from the retracted position to the extended position in response to the head-mounted device detecting an input and/or event that causes the head-mounted device to transition into a display-on mode. In some embodiments, the lens 1322 may be automatically rotated from the extended position to the retracted position in response to the head-mounted device detecting an input and/or event that causes the head-mounted device to transition into a display-off mode.

As used throughout the disclosure, the terms “display-on mode” and “display-off mode” should be interpreted broadly to include any two states of the head-mounted device that are different from one another. For example, the display-on mode may include a state of the head-mounted device in which the display of the head-mounted device is used to display content and the display-off mode may include a state in which the display of the head-mounted device is not used to display any content. As another example, the display-on mode may include a state of the head-mounted device in which the display of the head-mounted device is powered on or otherwise active, and the display-off mode may include a state of the head-mounted device in which the display of the head-mounted device is powered off or otherwise inactive.

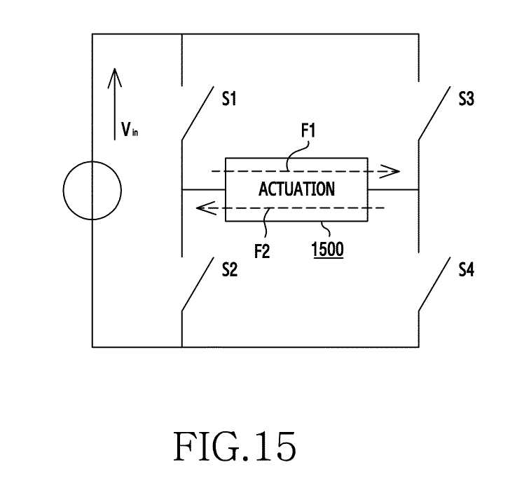

FIG. 15 is a diagram of an example of a circuit for controlling an actuator or actuation of a head-mounted device, according to an embodiment of the present disclosure.

As illustrated, the circuit may include an actuator 1500 and four switches S1, S2, S3, and S3 that are coupled to the actuator, as shown. According to an embodiment, if the first switch S1 and the fourth switch S4 are closed and the second switch S2 and the third switch S3 are open, current flowing to the actuator 1500 may flow in a first direction F1. Alternatively, if the second switch S2 and the third switch S3 are closed and the first switch S1 and the fourth switch S4 are open, current flowing to the actuator 1500 may flow in a second direction F2 (a direction opposite to the first direction F1).

A control of the aforementioned plurality of switches S1, S2, S3, and S4 may be performed by a controller (e.g., the MCU of FIG. 3). For example, the control of the plurality of switches S2, S2, S3, and S4 may be connected to the controller via any suitable type of interface, such as a General Purpose Input/Output (GPIO), an Inter-Integrated Circuit (I2C), a Serial Peripheral Interface (SPI), a Universal Asynchronous Receiver/Transmitter (UART), or the like.

According to an embodiment of the present disclosure, the head-mounted device 100 may include a display (e.g., the panel 3041) disposed in front of user's eyes and having a light transmittance, the Display Driver IC (DDI) 3042 for driving the display 3041, and the MCU 301 for controlling the DDI 3041.

According to an embodiment of the present disclosure, the head-mounted device 100 may further include a lens (e.g., the lens of the lens assembly 130) which can be disposed between the user's eyes and the display 3041.

According to an embodiment of the present disclosure, the head-mounted device 100 may further include the lens repositioning module 313 for repositioning the lens under the control of the controller 310.

According to an embodiment of the present disclosure, the lens repositioning module 313 may dispose the lens to overlap with the display 3041 if the display 3041 is activated, and may dispose the lens not to overlap with the display 3041 if the display 3041 is deactivated.

According to an embodiment of the present disclosure, the lens positioning module may include the fixed body 1310 having the through-hole 1310-2H through which the user can see straight the display 3041, the movable body 1320 which has the lens 1322 placed thereon and which can dispose the lens 1322 to overlap or not to overlap with the through-hole 1310-2H of the fixed body 1310 in a manner of rotating on the fixed body 1310, and the rotation device 1310-3 for enabling the movable body 1320 to rotate. Herein, the rotation device 1310-3 may allow the magnet 1326 connected to one side of the movable body 1320 to rotate by using an electromagnetic field generated by current.

According to an embodiment of the present disclosure, the lens positioning module 313 may adjust a distance between the display 3041 and the lens.

According to an embodiment of the present disclosure, the lens positioning module 313 may automatically reposition the lens to form a focal distance suitable for the user's eyes.

According to an embodiment of the present disclosure, the head-mounted device 100 may further include the eye tracking module 312 for tracking eye movements of the user.

According to an embodiment of the present disclosure, the MCU 301 may control the DDI 3042 to display content through a specific area corresponding to eye tracking information acquired from the eye tracking module 312 in a display area of the display 3041.

According to an embodiment of the present disclosure, the head-mounted device 100 may further include the light source 314 controlled by the MCU 301.

According to an embodiment of the present disclosure, the head-mounted device 100 may further include at least one sensor 3079 for measuring an illumination. Herein, the MCU 301 may control the light source 314 on the basis of the illumination acquired from the at least one sensor 3079.

According to an embodiment of the present disclosure, the controller 3079 may activate the light source 314 and adjust brightness of the light source 314 on the basis of the illumination if the illumination acquired from the at least one sensor 3079 is less than or equal to a threshold. Alternatively, the MCU 301 may deactivate the light source 314 if the illumination acquired from the at least one sensor 3079 is greater than the threshold.

According to an embodiment of the present disclosure, the display 3041 may include a plurality of light transmission areas disposed between a plurality of pixels.

According to an embodiment of the present disclosure, the light transmission areas of the display 3041 may include the through-hole 53.

According to an embodiment of the present disclosure, the display 3041 may include the Liquid Crystal Display (LCD) 400 or the Organic Light Emitting diode (OLED) 500.

According to an embodiment of the present disclosure, the head-mounted device 100 may further include the communication module 302 for communicating with another electronic device (e.g., the smartphone 1600) in a wired or wireless fashion.

According to an embodiment of the present disclosure, a method of operating the head-mounted device 100 may include the operation 1101 for activating the display 3041 having a light transmittance in response to a request for a display-on mode, and the operation 1105 for disposing a lens to a position overlapping with the display 3041 in response to the activation of the display 3041.

According to an embodiment of the present disclosure, the method of operating the head-mounted device 100 may further include the operation 1001 for deactivating the display 3041 in response to a request for a display-off mode, and the operation 1005 for disposing the lens to a position not overlapping with the display 3041 in response to the deactivation of the display 3041.

According to an embodiment of the present disclosure, the method of operating the head-mounted device 100 may further include the operation 907 for acquiring an illumination in response to the activation of the display 3041 (e.g., acquiring the illumination from the illumination sensor 3079), and the operation 913 for activating (or the operation 911 for deactivating) the light source 314 disposed around the display 3041 on the basis of the illumination.

According to an embodiment of the present disclosure, the method of operating the head-mounted device 100 may further include the operation 1205 for acquiring eye tracking information of a user (e.g., acquiring for the eye tracking information for the user from the eye tracking module 312), and the operation 1207 for displaying content through a specific area in a display area of the display 3041 on the basis of the eye tracking information.

An external electronic device capable of communicating with the head-mounted device 100 may be a device including a communication function. For example, the external electronic device may include at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a MPEG-1 Audio Layer 3 (MP3) player, a mobile medical device, a camera, and a wearable device (e.g., a Head-Mounted-Device (HMD) such as electronic glasses, electronic clothes, an electronic bracelet, an electronic necklace, an electronic appcessory, an electronic tattoo, a smart watch).

According to various embodiments of the present disclosure, the external electronic device may be a smart home appliance having a communication function. For example, the smart home appliance, for example, the external electronic device, may include at least one of a TeleVision (TV), a Digital Video Disk (DVD) player, an audio, a refrigerator, an air conditioner, a cleaner, an oven, a microwave oven, a washing machine, an air purifier, a set-top box, a TV box (e.g., Samsung HomeSync™, Apple TV™, or Google TV™), a game console, an electronic dictionary, an electronic key, a camcorder, and an electronic picture frame.

According to various embodiments of the present disclosure, the external electronic device may include at least one of various medical devices (e.g., Magnetic Resonance Angiography (MRA), Magnetic Resonance Imaging (MRI), Computed Tomography (CT), imaging equipment, ultrasonic instrument, etc.), a navigation device, a Global Positioning System (GPS) receiver, an Event Data Recorder (EDR), a Flight Data Recorder (FDR), a car infotainment device, an electronic equipment for ship (e.g., a vessel navigation device, a gyro compass, etc.), avionics, a security device, a car head unit, an industrial or domestic robot, an Automatic Teller's Machine (ATM) of financial institutions, and Point Of Sales (POS) of shops.

According to various embodiments of the present disclosure, the external electronic device may include at least one of a furniture or a part of building/constructions including a communication function, an electronic board, an electronic signature receiving device, a projector, and various measurement machines (e.g., water supply, electricity, gas, propagation measurement machine, etc.). The external electronic device according to an embodiment of the present disclosure may be one or more combinations of the aforementioned various devices. In addition, the external electronic device according to an embodiment of the present disclosure may be a flexible device. It is apparent those ordinarily skilled in the art that the external electronic device according to an embodiment of the present disclosure is not limited to the aforementioned devices.

Hereinafter, the external electronic device according to various embodiments will be described with reference to the accompanying drawings. A term ‘user’ used in various embodiments may refer to a person who uses the external electronic device, or a device (e.g., an artificial intelligence electronic device) which uses the external electronic device.

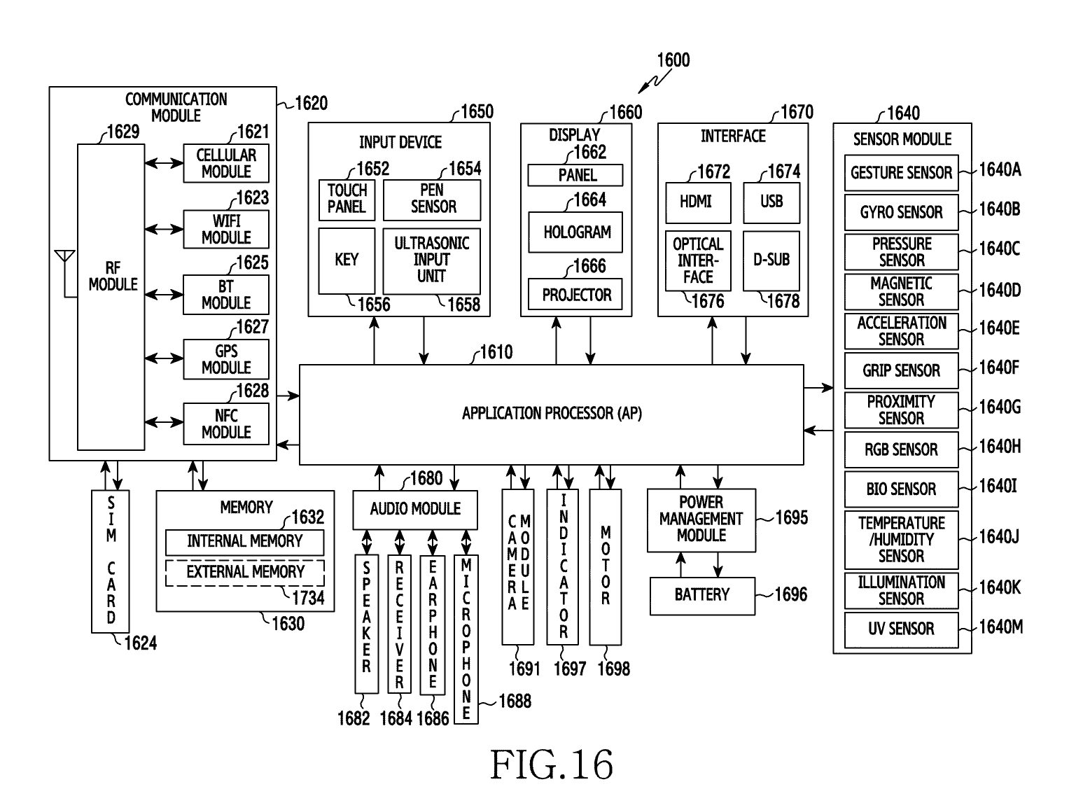

FIG. 16 is a block diagram of an example of an external electronic device capable of communicating with the head-mounted device 100, according to an embodiment of the present disclosure. For example, the external electronic device may include a smartphone.

FIG. 16 illustrates a block diagram of the smartphone according to an embodiment of the present disclosure. For example, a smartphone 1600 may constitute all or some parts of the smartphone 1600 of FIG. 16. Referring to FIG. 16, the smartphone 1600 includes at least one Application Processor (AP) 1610, a communication module 1620, a Subscriber Identification Module (SIM) card 1624, a memory 1630, a sensor module 1640, an input device 1650, a display 1660, an interface 1670, an audio module 1680, a camera module 1691, a power management module 1695, a battery 1696, an indicator 1697, and a motor 1699.

The AP 1610 may control a plurality of hardware or software constitutional elements connected to the AP 1610 by driving an operating system or an application program, and may process a variety of data including multimedia data and may perform an arithmetic operation. The AP 1610 may be implemented, for example, with a System on Chip (SoC). According to an embodiment, the AP 1610 may further include a Graphic Processing Unit (GPU, not shown).

The communication module 1620 may perform data transmission/reception in communication between other electronic devices connected with the smartphone 1600 through a network. According to an embodiment, the communication module 1620 may include a cellular module 1621, a Wi-Fi module 1623, a Bluetooth (BT) module 1625, a Global Positioning System (GPS) module 1627, a Near Field Communication (NFC) module 1628, and a Radio Frequency (RF) module 1629.

The cellular module 1621 may provide a voice call, a video call, a text service, an internet service, and the like through a communication network (e.g., LTE, LTE-A, CDMA, WCDMA, UMTS, WiBro, GSM, etc.). In addition, the cellular module 1621 may identify and authenticate the electronic device within the communication network by using a subscriber identity module (e.g., the SIM card 1624). According to an embodiment, the cellular module 1621 may perform at least some of functions that can be provided by the AP 1610. For example, the cellular module 1621 may perform at least some of multimedia control functions.

According to an embodiment, the cellular module 1621 may include a Communication Processor (CP). Further, the cellular module 1621 may be implemented, for example, with a SoC. Although constitutional elements such as the cellular module 1621 (e.g., the communication processor), the memory 1630, the power management module 1695, and the like are illustrated as separate constitutional elements with respect to the AP 1610 in FIG. 16, the AP 1610 may also be implemented such that at least one part (e.g., the cellular module 1621) of the aforementioned constitutional elements is included.

According to an embodiment, the AP 1610 or the cellular module 1621 (e.g., the communication processor) may load an instruction or data, which is received from each non-volatile memory connected thereto or at least one of different constitutional elements, to a volatile memory and may process the instruction or data. In addition, the AP 1610 or the cellular module 1621 may store data, which is received from at least one of different constitutional elements or generated by at least one of different constitutional elements, into the non-volatile memory.

Each of the Wi-Fi module 1623, the BT module 1625, the GPS module 1627, and the NFC module 1628 may include, for example, a processor for processing data transmitted/received through a corresponding module. Although the cellular module 1621, the Wi-Fi module 1623, the BT module 1625, the GPS module 1627, and the NFC module 1628 are illustrated in FIG. 16 as separate blocks, according to an embodiment, at least some (e.g., two or more) of the cellular module 1621, the Wi-Fi module 1623, the BT module 1625, the GPS module 1627, and the NFC module 1628 may be included in one Integrated Chip (IC) or IC package. For example, at least some of processors corresponding to the cellular module 1621, the Wi-Fi module 1623, the BT module 1625, the GPS module 1627, and the NFC module 1628 (e.g., a communication processor corresponding to the cellular module 1621 and a Wi-Fi processor corresponding to the Wi-Fi module 1623) may be implemented with a SoC.

The RF module 1629 may serve to transmit/receive data, for example, to transmit/receive an RF signal. Although not shown, the RF module 1629 may include, for example, a transceiver, a Power Amp Module (PAM), a frequency filter, a Low Noise Amplifier (LNA), and the like. In addition, the RF module 1629 may further include a component for transmitting/receiving a radio wave on a free space in wireless communication, for example, a conductor, a conducting wire, and the like. Although it is illustrated in FIG. 16 that the cellular module 1621, the Wi-Fi module 1623, the BT module 1625, the GPS module 1627, and the NFC module 1628 share one RF module 1629, according to an embodiment, at least one of the cellular module 1621, the Wi-Fi module 1623, the BT module 1625, the GPS module 1627, the NFC module 1628 may transmit/receive an RF signal via a separate RF module.

The SIM card 1624 may be a card in which a SIM is implemented, and may be inserted to a slot formed at a specific location of the electronic device. The SIM card 1624 may include unique identification information (e.g., an Integrated Circuit Card IDentifier (ICCID)) or subscriber information (e.g., an International Mobile Subscriber Identity (IMSI)).

The memory 1630 may include an internal memory 1632 or an external memory 1634. The internal memory 1632 may include, for example, at least one of a volatile memory (e.g., a Dynamic RAM (DRAM), a Static RAM (SRAM), a Synchronous Dynamic RAM (SDRAM), etc.) or a non-volatile memory (e.g., a One Time Programmable ROM (OTPROM), a Programmable ROM (PROM), an Erasable and Programmable ROM (EPROM), an Electrically Erasable and Programmable ROM (EEPROM), a Mask ROM, a Flash ROM, a NAND flash memory, a NOR flash memory, etc.).

According to an embodiment, the internal memory 1632 may be a Solid State Drive (SSD). The external memory 1634 may further include a flash drive, and may further include, for example, Compact Flash (CF), Secure Digital (SD), Micro Secure Digital (Micro-SD), Mini Secure digital (Mini-SD), extreme Digital (xD), memory stick, and the like. The external memory 1634 may be operatively coupled to the smartphone 1600 via various interfaces. According to an embodiment, the smartphone 1600 may further include a storage unit (or a storage medium) such as a hard drive.

The sensor module 1640 may measure a physical quantity or detect an operation state of the smartphone 1600, and thus may convert the measured or detected information into an electric signal. The sensor module 1640 may include, for example, at least one of a gesture sensor 1640A, a gyro sensor 1640B, a pressure sensor 1640C, a magnetic sensor 1640D, an acceleration sensor 1640E, a grip sensor 1640F, a proximity sensor 1640G, a color sensor 1640H (e.g., a Red, Green, Blue (RGB) sensor), a biosensor 1640I, a temperature/humidity sensor 1640J, an illumination sensor 1640K, and an Ultra Violet (UV) sensor 1640M. Additionally or alternatively, the sensor module 1640 may include, for example, an E-nose sensor (not shown), an ElectroMyoGraphy (EMG) sensor (not shown), an ElectroEncephaloGram (EEG) sensor (not shown), an ElectroCardioGram (ECG) sensor (not shown), an Infra Red (IR) sensor (not shown), an iris sensor (not shown), a fingerprint sensor (not shown), and the like. The sensor module 1640 may further include a control circuit for controlling at least one or more sensors included therein.

The input device 1650 may include a touch panel 1652, a (digital) pen sensor 1654, a key 1656, or an ultrasonic input unit 1658. The touch panel 1652 may recognize a touch input, for example, by using at least one of an electrostatic type, a pressure-sensitive type, and an ultrasonic type. In addition, the touch panel 1652 may further include a control circuit. In case of the electrostatic type, not only a physical contact but also a proximity recognition is possible. The touch penal 1652 may further include a tactile layer. In this case, the touch panel 1652 may provide the user with a tactile reaction.

The (digital) pen sensor 1654 may be implemented, for example, by using the same or similar method of receiving a touch input of the user or by using an additional sheet for recognition. The key 1656 may be, for example, a physical button, an optical key, a keypad, or a touch key. The ultrasonic input unit 1658 is a device by which the smartphone 1600 detects a sound wave through a microphone 1688 by using a pen which generates an ultrasonic signal, and is a device capable of radio recognition. According to an embodiment, the smartphone 1600 may use the communication module 1620 to receive a user input from an external device (e.g., a computer or a server) connected thereto.

The display 1660 may include a panel 1662, a hologram 1664, or a projector 1666. The panel 1662 may be, for example, a Liquid-Crystal Display (LCD), an Active-Matrix Organic Light-Emitting Diode (AM-OLED), and the like. The panel 1662 may be implemented, for example, in a flexible, transparent, or wearable manner. The panel 1662 may be constructed as one module with the touch panel 1652. The hologram 1664 may use an interference of light and show a stereoscopic image in the air. The projector 1666 may display an image by projecting a light beam onto a screen. The screen may be located, for example, inside or outside the smartphone 1600. According to an embodiment, the display 1660 may further include a control circuit for controlling the panel 1662, the hologram 1664, or the projector 1666.

The interface 1670 may include, for example, a High-Definition Multimedia Interface (HDMI) 1672, a Universal Serial Bus (USB) 1674, an optical interface 1676, or a D-subminiature (D-sub) 1678. Additionally or alternatively, the interface 1670 may include, for example, a Mobile High-definition Link (MHL) interface, a Secure Digital (SD)/Multi-Media Card (MMC) interface, or an Infrared Data Association (IrDA) standard interface.

The audio module 1680 may bilaterally convert a sound and electronic signal. The audio module 1680 may convert sound information which is input or output, for example, through a speaker 1682, a receiver 1684, an earphone 1686, the microphone 1688, and the like.

The camera module 1691 is a device for image and video capturing, and according to an embodiment, may include one or more image sensors (e.g., a front sensor or a rear sensor), a lens (not shown), an Image Signal Processor (ISP) (not shown), or a flash (not shown, e.g., LED or xenon lamp).

The power management module 1695 may manage a power of the smartphone 1600. Although not shown, the power management module 1695 may include, for example, a Power Management Integrated Circuit (PMIC), a charger Integrated Circuit (IC), or a battery fuel gauge.

The PMIC may be placed, for example, inside an IC or SoC semiconductor. Charging may be classified into wired charging and wireless charging. The charger IC may charge a battery, and may avoid an over-voltage or over-current flow from a charger. According to an embodiment, the charger IC may further include a charger IC for at least one of the wired charging and the wireless charging. The wireless charging may be classified into, for example, a magnetic resonance type, a magnetic induction type, and an electromagnetic type. An additional circuit for the wireless charging, for example, a coil loop, a resonant circuit, a rectifier, and the like, may be added.

The battery gauge may measure, for example, a residual quantity of the battery 1696 and a voltage, current, and temperature during charging. The battery 1696 may store or generate an electricity, and may supply a power to the smartphone 1600 by using the stored or generated electricity. For example, the battery 1696 may include a rechargeable battery or a solar battery.

The indicator 1697 may indicate a specific state, for example, a booting state, a message state, a charging state, or the like, of the smartphone 1600 or a part thereof (e.g., the AP 1610). The motor 1699 may convert an electric signal into a mechanical vibration. Although not shown, the smartphone 1600 may include a processing unit (e.g., a GPU) for supporting a mobile TV. The processing unit for supporting the mobile TV may process media data, for example, according to a protocol of Digital Multimedia Broadcasting (DMB), Digital Video Broadcasting (DVB), media flow, or the like.

Methods based on the embodiments disclosed in the claims and/or specification of various embodiments of the present disclosure can be implemented in hardware, software, or a combination of both. When implemented in software, computer readable recording medium for storing one or more programs (i.e., software modules) can be provided. The one or more programs stored in the computer readable recording medium are configured to be executed by one or more processors in an electronic device. The one or more programs include instructions for allowing the electronic device to execute the methods based on various embodiments disclosed in the claims and/or specification of the present disclosure.

FIGS. 1-16 are provided as an example only. At least some of the operations discussed with respect to these figures can be performed concurrently, performed in a different order, and/or altogether omitted. It will be understood that the provision of the examples described herein, as well as clauses phrased as “such as,” “e.g.,” “including,” “in some aspects,” “in some implementations,” and the like should not be interpreted as limiting the claimed subject matter to the specific examples. It will further be understood that the phrase “incident light sample” may refer to a sample of light that is incident on a sensor taking the sample and/or a sample of light that is incident on an imaging sensor.

The above-described embodiments of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, or combination hardware configured with machine executable code and may be performed in whole or in part within the programmed instructions of a computer. No claim element herein is to be construed under the provisions of 35 U.S.C. 112, sixth paragraph, unless the element is expressly recited using the phrase “means for”.

Further, the program can be stored in an attachable storage device capable of accessing the electronic device through a communication network such as the Internet, an Intranet, a Local Area Network (LAN), a Wide LAN (WLAN), or a Storage Area Network (SAN) or a communication network configured by combining the networks. The storage device can access the electronic device via an external port. In addition, an additional storage unit on a communication network can access a device for performing an embodiment of the present disclosure.

In the aforementioned specific example embodiments of the present disclosure, a constitutional element included in the disclosure is expressed in a singular or plural form according to the specific example embodiment proposed herein. However, the singular or plural expression is selected properly for a situation proposed for the convenience of explanation, and thus the various embodiments of the present disclosure are not limited to a single or a plurality of constitutional elements. Therefore, a constitutional element expressed in a plural form can also be expressed in a singular form, or vice versa.

While embodiments of the present disclosure have been shown and described with reference to certain preferred embodiments thereof, it will be understood by those skilled in the art that various changes in form and details may be made therein without departing from the spirit and scope of the disclosure as defined by the appended claims. While the present disclosure has been particularly shown and described with reference to embodiments thereof, it will be understood by those skilled in the art that various changes in form and details may be made therein without departing from the spirit and scope of the present disclosure as defined by the appended claims.

What is claimed is:

1. A head-mounted device comprising:
a see-through display having an inner surface and an outer surface;
a Display Driver Integrated Circuit (DDIC) for driving the display; and
at least one processor for controlling the DDIC.

2. The device of claim 1, further comprising a lens disposed adjacently to the inner surface of the display.

3. The device of claim 2, further comprising a lens positioning module for repositioning the lens under control of the processor.

4. The device of claim 3, wherein the lens positioning module is arranged to extend the lens to an extended position in which the lens overlaps with the display, and retract the lens from the extended position to a retracted position in which the lens does not to overlap with the display.

5. The device of claim 4, wherein the lens positioning module comprises:
a fixed body having a through-hole for viewing the display;
a movable body receiving the lens; and
a rotation device coupled to the movable body, wherein the rotation device is arranged to extend and retract the lens by rotating the movable body between the extended position and the retracted position.

6. The device of claim 3, wherein the lens positioning module is arranged to change a distance between the display and the lens.

7. The device of claim 6, wherein the lens positioning module automatically changes the distance between the lens and the display based on biometric information associated with a user.

8. The device of claim 1, further comprising an eye tracking module.

9. The device of claim 8, wherein the controller controls the DDIC to display content at a location that is selected based on a signal received from the eye tracking module.

10. The device of claim 1, further comprising a light source controlled by the processor.

11. The device of claim 10, further comprising at least one ambient illumination sensor, wherein the processor is further configured to control the light source based on a signal from the ambient illumination sensor that indicates an amount of available ambient illumination.

12. The device of claim 11, wherein controlling the light source includes at least one of:
(a) turning on the light source based on the amount of available ambient illumination,
(b) turning off the light source based on the amount of available ambient illumination, and
(c) adjusting a brightness of the light source based on the amount of available ambient illumination.

13. The device of claim 1, wherein the display includes a plurality of light-transmissive areas disposed between different pixels of the display.

14. The device of claim 13, wherein each of the light-transmissive areas comprises a through-hole.

15. The device of claim 1, wherein the display comprises a Liquid Crystal Display (LCD) or an Organic Light Emitting Diode (OLED).

16. The device of claim 1, further comprising a communication module for communicating with another electronic device.

17. A method for operating a head-mounted device having a see-through display and a lens, the method comprising:
detecting, by the head-mounted device, a first input;
activating the see-through display, in response to the first input; and
extending the lens to an extended position at which the lens overlaps with the see-through display, in response to the first input.

18. The method of claim 17, further comprising:
detecting, by the head-mounted device, a second input;
deactivating the display, in response to the second input; and
retracting the lens to a retracted position at which the lens does not overlap with the see-through display, in response to the second input.

19. The method of claim 17, further comprising:
receiving an indication of an amount of available ambient illumination when the see-through display is activated; and
activating or deactivating a light source of the display based on the amount of available ambient illumination.

20. The method of claim 17, further comprising displaying content in a portion of the display that is selected based on eye-tracking information associated with a user of the head-mounted device.
